(19) United States
(12) Patent Application Publication
(10) Pub. No.: US 2023/0058040 A1
(43) Pub. Date: Feb. 23, 2023

(54) INTERFACE SATELLITE

(71) Applicant: HEDRON SPACE INC., Pawtucket, RI (US)

(72) Inventors: Daniel NEVIUS, Pawtucket, RI (US); Anthony CLARK, Pawtucket, RI (US); Aidan KLUPAR, Pawtucket, RI (US); Joel FAURE, Pawtucket, RI (US); Weston Alan MARLOW, Pawtucket, RI (US)

(21) Appl. No.: 17/797,880

(22) PCT Filed: Dec. 7, 2020
(86) PCT No.: PCT/US20/63607

§ 371 Date: Aug. 5, 2022

Related U.S. Application Data
(60) Provisional application No. 62/971,436, filed on Feb. 7, 2020.

(51) Int. Cl. H04B 7/185; H04B 7/195

(52) U.S. Cl. CPC H04B 7/18521; H04B 7/195; H04B 7/18513; B64G 1/1007

(57) ABSTRACT

A multi-user satellite system provides communication services to external satellites. This satellite system provides in-orbit access points that can be used by the external satellites to offload data instead on relying directly on ground stations. One approach to such communication is to use a set of interface satellites (“converter satellites”) that provide a gateway between a constellation of satellites that together provide communication services to one or more ground stations, but that do not necessarily have the communication capabilities to communicate with external satellites. In this way, the interface satellites can be put in compatible orbits with external satellites and provide communication gateways that can be used to offload data from the external satellites to ground stations. As external satellites change their communication methods, the interface satellites can be reconfigured or new compatible interface satellites can be launched, without having to modify the constellation of satellites.

### CROSS-REFERENCE TO RELATED APPLICATIONS

This application claims the benefit of U.S. Provisional Application No. 62/971,436, filed on Feb. 7, 2020, the contents of which are incorporated herein by reference.

### GOVERNMENT LICENSE RIGHTS

This invention was made with Government support under contract number FA8808-20-C-0016 awarded by the Air Force. The Government has certain rights in the invention.

### BACKGROUND OF THE INVENTION

This invention relates to an interface satellite for providing communication services.

Use of satellites to generate remote sensing data has become increasingly accessible to government and commercial entities. For example, relatively inexpensive low-earth-orbit (LEO) satellites can be launched to acquire satellite images for particular applications. However, although the cost of constructing and launching satellites may have been dramatically reduced in recent years, offloading data collected at a satellite remains relatively complex and expensive. Referring to FIG. 1, one typical scenario involves a satellite 160A acquiring images of the earth surface 190, for example, represented schematically as an imaging region 165A. In general, there are only a limited number of ground stations 110 available to offload the data, and the satellite 160A may not always be in range of an available ground station to offload. In such a scenario, the satellite may store acquired data and wait until it is in range of a ground station. For example, satellite 160B (which may be satellite 160A illustrated at a later time on its orbital path 160) offloads its data to the ground station 110 over a radio frequency link 115B. This results in delays in making the data available for earth-based computation, and the amount of data may be limited by the storage capacity available on the satellite. Furthermore, a satellite operator will in general have to contract with existing ground stations or ground station networks, which can result in substantial cost and potential inflexibility in the offloading of data.

Satellite networks are also being deployed to augment earth-based communication links. Referring to FIG. 2, some such systems make use of constellations of LEO satellites 130A-B (only two are shown on their respective orbits 132A-B, but in general 10s or 100s of such satellites may form a constellation). Communication between two points on the earth's surface 190 pass between ground stations 110A-B. In general, a ground station 110A communicates with one of the satellites 130A, which is at that time in the range of the ground station. In some systems, a store-and-forward approach is used in which data packets are passed between satellites, for example, from satellite 130A to satellite 130B. The data packets ultimately reach a satellite that is in range of the destination ground station 110B, and the data is passed from the satellite 130B to the ground station 110B. In some systems, in addition to LEO satellites, one or more additional satellites 120 at higher orbit (e.g., in geo-stationary or mid-altitude orbits) can participate with the LEO constellation to pass data packets on a path from an originating ground station 110A to a destination ground station 110B.

### SUMMARY OF THE INVENTION

Although the cost of constructing and launching LEO satellites has greatly decreased in recent years, the complexity and/or cost of communication with such satellites, for example, for offloading acquired data, or for telemetry and control function, remains relatively high. Furthermore, many satellite components are not specifically associated with a mission payload (e.g., satellite image acquisition) and are rather related to the relatively complex task of communication with ground stations. Such components can add to the cost and complexity to deploying a satellite for a particular mission and may limit the capacity of the satellite for hosting mission-related components. There is therefore a need to provide a relatively simple and cost-effective way for satellites to offload their data, preferably with low latency.

In one aspect, in general, a multi-user satellite system provides communication services to external satellites. This satellite system provides in-orbit access points that can be used by the external satellites to offload data instead on relying directly on ground stations. One approach to such communication is to use a set of interface satellites (“converter satellites”) that provide a gateway between a constellation of satellites that together provide communication services to one or more ground stations, but that do not necessarily have the communication capabilities to communicate with external satellites. In this way, the interface satellites can be put in compatible orbits with external satellites and provide communication gateways that can be used to offload data from the external satellites to ground stations. As external satellites change their communication methods, the interface satellites can be reconfigured or new compatible interface satellites can be launched, without having to modify the constellation of satellites.

In another aspect, in general, a communication system includes a plurality of interface satellites configured to communication with satellites of a constellation of satellites. The system also includes a ground-based controller in communication with the plurality of interface satellites. The system is configured to provide a communication service to at least one external satellite, the communication service providing a data path from the external satellite via one or more of the plurality of interface satellites and the constellation of satellites to a ground station.

Aspects can include one or more of the following features.

The constellation of satellites provides communication services between satellites of said constellation and the ground station.

The constellation of satellites is operated independently of the interface satellites.

The constellation of satellites is part of the communication system.

The ground-based controller is configured to receive a connection request from an operator of the external satellite, and to provide connection information to the operator sufficient for said operator to configure the external satellite to communicate with the one of more of the interface satellites.

The connection information comprises location information for at least one of the system satellite and time information specifying a time for the communication between the external satellite and one or more of the interface satellites.

The ground-based controller is configured to receive tracking information of the system satellites suitable for predicting orbital information for said interface satellites, and to receive tracking information for the external satellite, and to determine the connection information based on said received tracking information for the interface and external satellites.

The connection request includes a specification of a communication method for use in communicating with the external satellite, and the ground station is configured to instruct at least on interface satellite to configure a communication component to use the communication method for communicating with the external satellite.

The specification of the communication method includes at least one of a communication frequency, a communication protocol, and a signaling modem.

At some of the interface satellites include reconfigurable communication components for communicating with the at least one external satellite.

At least some of the interface satellites are reconfigurable based on commands from the ground-based controller.

At least some of the interface satellites are reconfigurable to emulate a communication method of a satellite ground station compatible with the at least one external satellite.

The ground-based controller is configured to receive a connection request from an operator of the external satellite, and to provide connection information from the operator sufficient for the ground-based controller to take at least some control of the external satellite for the purpose of establishing communication with the one of more of the interface satellites.

Other features and advantages of the invention are apparent from the following description, and from the claims.

### BRIEF DESCRIPTION OF THE DRAWINGS

FIG. 1 is diagram illustrating satellite data acquisition and subsequent data offloading to a ground station.

FIG. 2 is a diagram of a satellite communication system providing communication services between ground stations.

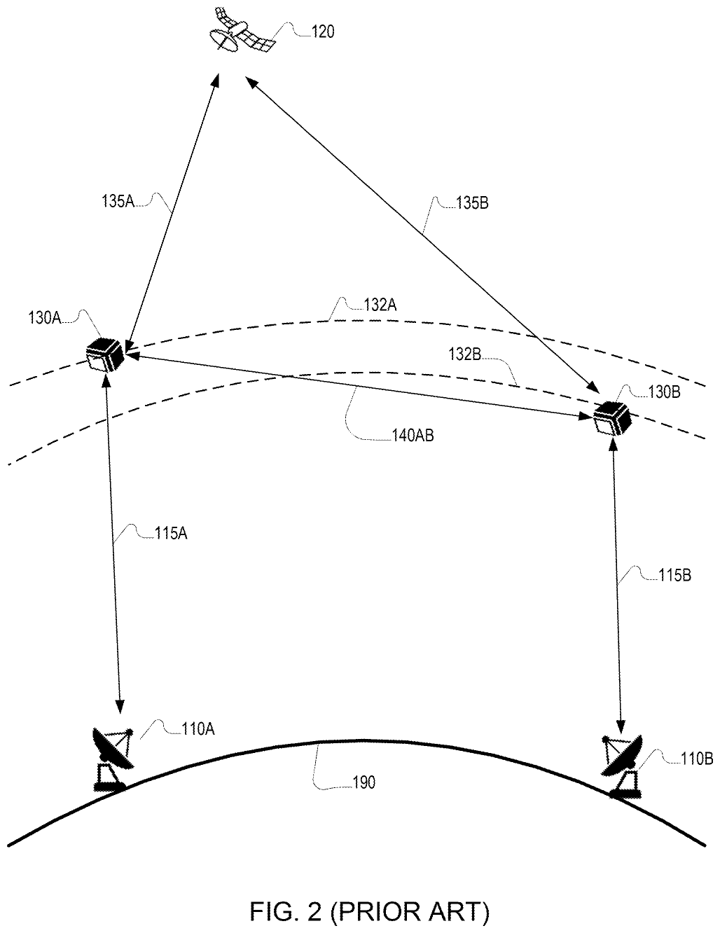

FIG. 3 is a diagram of a satellite communication system providing communication services between satellites and ground stations.

FIG. 4 is a diagram of a satellite constellation forming a data network.

FIG. 5 is an example of a satellite forming part of the constellation.

FIG. 6 is another example of a satellite forming part of the constellation.

FIG. 7 is a satellite that provides communication services to an external satellite and means for communicating with the constellation of satellites forming a communication network.

FIG. 8 is a diagram illustrating use of a converter satellite providing a communication bridge between an external satellite and a constellation of satellites forming a communication network.

### DETAILED DESCRIPTION

### 1 Overview

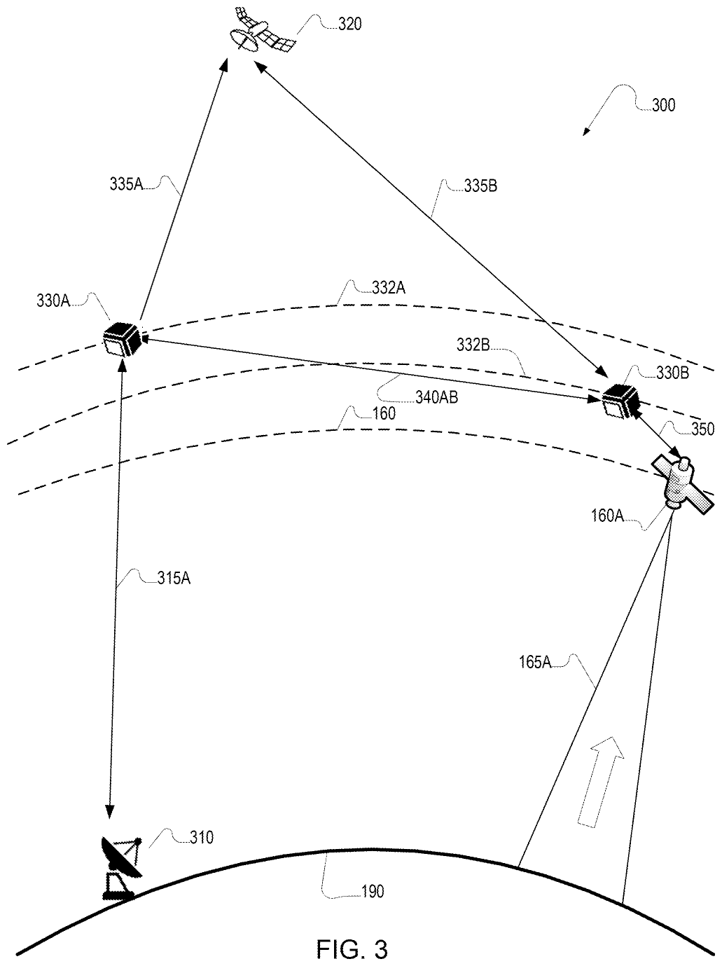

Referring to FIG. 3, a satellite system 300 includes a constellation of low-earth-orbit (LEO) satellites, including two representative satellites 330A-B in respective orbits 332A-B, and a set of generally multiple ground stations, including a representative ground station 310. Optionally, the system includes additional satellites at higher orbits, illustrated as a representative satellite 320. Generally, the satellite system 300 provides communication services to one or more external satellites, including an external satellite 160A. In the example, illustrated in FIG. 3, the satellite 160A acquires earth image data, and passes that data via the satellite system 300 to the ground station 310.

In the discussion below, the satellite system 300 is described to include “internal” satellites, which in general are devoted to providing the infrastructure needed to support communication services to “external” satellites. These external satellites are generally focused at particular data acquisition (or other data generating or data consuming) missions but are not required for the operation of the satellite system 300 itself. In some examples described in this document, the external satellites remain separately controlled by the operators of those satellites, while in other examples, at least partial control of aspects of the external satellites is controlled in conjunction with the satellite system, for example, for synchronization or acquisition of communication channels.

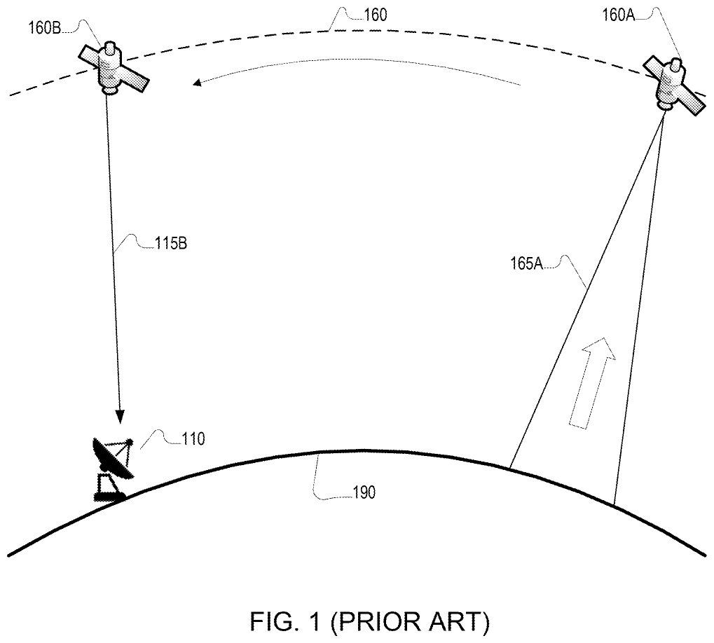

Rather than the satellite 160A communicating directly with a ground station, for example, as illustrated in FIG. 1 with satellite 160B communicating with ground station 110, the satellite 160A establishes a communication link with one of the satellites of the system, illustrated in FIG. 1 as a link 350 with an internal satellite 330B. As discussed in more detail below, there are various ways in which such a link 350 may be established.

In some examples, the satellite 160A is configured to communicate with the satellite 330B using communication techniques native to the satellite system 300. For example, the satellite system 300 may use optical or radio-frequency interconnections between the satellites 330A-B, and the satellite 160A is constructed to include the necessary communication hardware to use the same type of link.

In some examples, the satellite 160A may use the communication capabilities (e.g., frequencies, protocols, etc.) that where originally (e.g., at the time of launch) intended for communication with a ground station, for example, using radio-frequency communication in a particular frequency band and using a particular communication protocol. For example, the satellite 160A is a legacy system that was designed and deployed before the system 300 was specified. In such an example, the internal satellite 330B essentially provides a communication endpoint that mimics a ground station such that the link 350 essentially uses the same communication approach as, for example, the communication link 115B in FIG. 1.

Various types of communication services may be provided, including packet-based and/or store-and-forward services, as well as continuous channel services that enable the satellite 350 to send a continuous data stream ultimately arriving at the ground station 310 over what may be referred to as a “bent pipe”, for example, passing from the satellite 160A, via satellite 330B and then satellite 330A before reaching the ground station 315A.

Turning to the internal operation of the satellite system 300, each of the satellites supports multiple communication channels. Such communication channels are generally:
1. Inter-satellite channels in one orbital range (e.g., LEO)
2. Satellite-ground station channels
3. Inter-satellite channels between orbital ranges (e.g., LEO-GEO)
4. Access channels between external satellites to internal satellites.

It should be recognized that the system may include internal satellites that do not all support all these types of channels, although to be useful, a satellite would have at least two channels to participate in the communication services of the system. Furthermore, different communication approaches may be used for different channels. For example, optical links may be used for the inter-satellite channels while radio-frequency links may be used for communication with ground stations and/or external satellites.

### 2 Operation of Internal Satellites

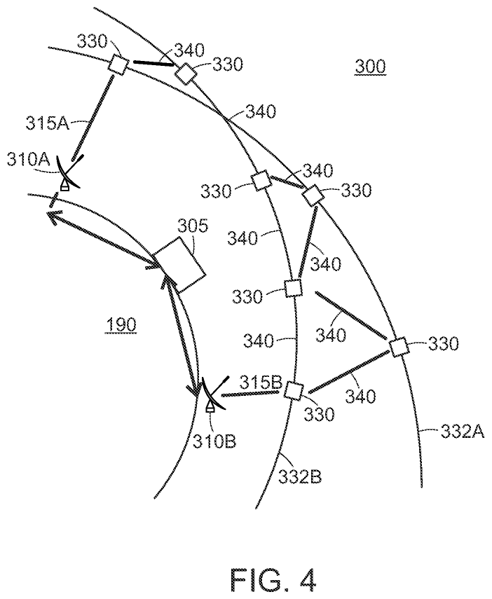

Before addressing multi-user access to the satellite system 300, the manner in which the constellation of internal satellites 330 is controlled is described below. Referring to FIG. 4, the constellation of satellites 330 travel along multiple orbits, representative orbits 332A and 332B being shown in FIG. 4. Subsets of the satellites at least sometimes are in contact with ground stations, with representative ground stations 310A and 310B being illustrated in contact over radio or optical links 315A and 315B, respectively. A centralized tracking system 305 instructs the ground stations to track the satellites based on the prediction of the paths of the satellites. That is, the ground station has sufficient information to predict when various of the satellites 330 are in view of the ground stations, and the ground stations receive instructions to track those satellites.

During the orbits of the satellites 330, in general each satellite is in view of at least one other satellite, permitting it to establish a communication link 340 between the satellites preferably over an optical link, although radio frequency links can also be used. In general, the communication systems are directional, for example, with directional optics or directional radio frequency antennas or phased arrays, and therefore while in communication, the satellites track one another to maintain the communication links, terminating links and establishing new links as different satellites leave or come into view. Generally, the satellites receive at least some location or tracking information from the tracking system 305 to determine when they should establish links with particular other satellites and location or orbit information to help establish the links. Similarly, the satellites 305 are instructed to communicate with particular ground stations when they are in view.

The combination of ground station to satellite links (e.g., 315A-B) and inter satellite links 340 form a data network permitting generally multi-hop communication between satellites and the ground stations, preferably maintaining a multi-hop network link between each satellite 330 and the tracking system 305 at all times, although the system can also function with some satellites being disconnected from the network from time to time. In some examples, the network provides transport of packet-based communication between satellites and ground locations using a transport protocol, for example, providing packet-based datagram or session-based communication services and using a store-and-forward approach at each of the satellites in order to achieve packet delivery from source to destination locations in the network.

The tracking system 305 receives telemetry information from the satellites over the network. This information is sufficient for the tracking system to predict their upcoming future trajectories in orbit, as well as other operational parameters, such as degree of battery charge, charging capacity from photo arrays on the satellites, temperature, etc. Based on the information from the satellites the tracking system plans the network topology over an upcoming period, and distributes instructions to the satellites and ground stations sufficient for those systems to track each other and maintain the planned network connections. Because of the packet-network structure, there is a degree of resilience in the network permitting at least some links and/or entire satellites to be inoperative at any one time while still maintaining overall network connectively.

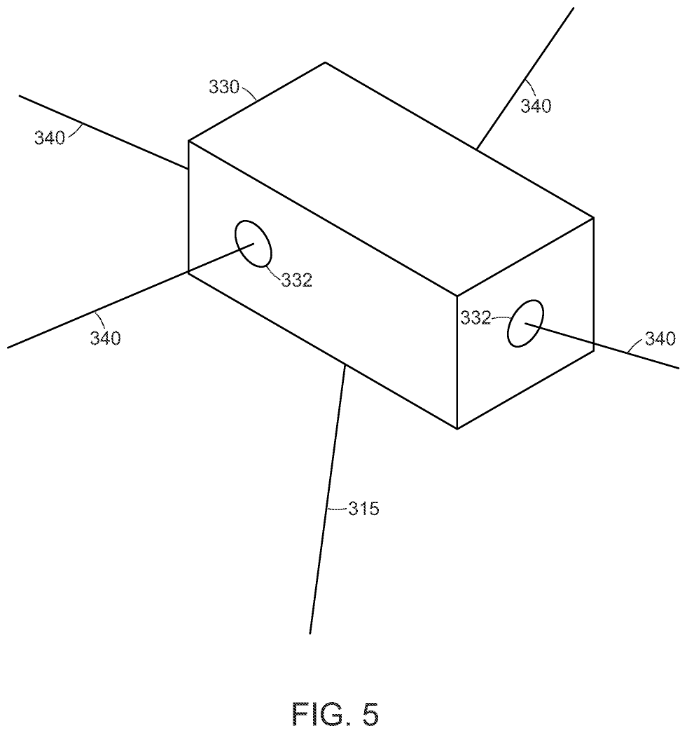

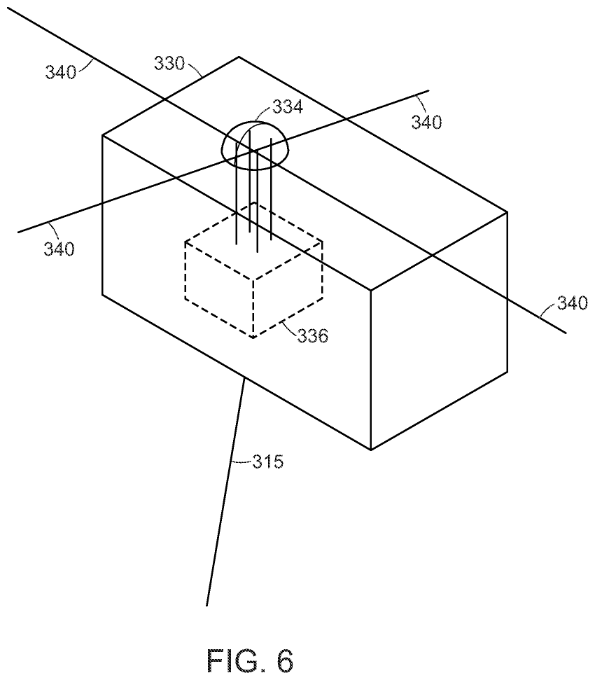

Referring to FIG. 5, an example of an internal satellite 330 includes a number of communication components 332, in the example of FIG. 5 representing steerable optical components suitable for maintaining inter-satellite links at the instruction of the tracking system 305. In this example, each communication component 332 is used for a respective inter-satellite link 340. The satellite also includes an additional communication component for communicating with a ground station over a link 315. For example, communication component may be an addition steerable optical component, a steerable radio frequency antenna (e.g., a “dish”), or a steerable phased array with multiple separate antennas forming the array. The satellites themselves may also be the steerable elements, i.e. bus pointing. Referring to FIG. 6, and alternative example of an internal satellite 330 uses a multiple link optical component 334, which provides the optics (e.g., a system of a plurality of lenses) for supporting multiple links 340 with signals generated by an optical controller 335. Of course, yet other arrangements of communication components on the satellites 330 can be used to maintain inter-satellite and satellite-ground communication links. Furthermore, as introduced above an illustrated in FIG. 3, the satellites may communicate with satellites at other orbital altitudes and/or in geostationary orbits, and suitable optical or radio frequency components are included in the satellites 330 to support such communication.

### 3 External Satellite Access

As introduced above, the satellite system 300 can have any number of internal satellites 330 and ground stations 310 working together to coordinate and route data among one another. Using this established network, the system provides communication services to one or more external satellites 160, for example as illustrated in FIG. 3.

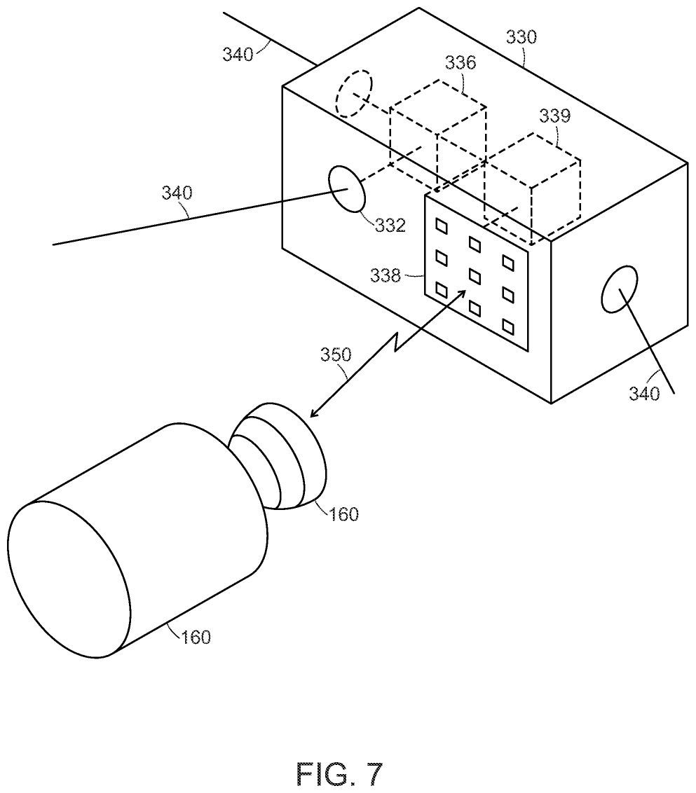

Referring to FIG. 7, in one embodiment, some or all of the satellites 330 include communication components suitable for communicating with an external satellite 160 using that external satellite's native communication capabilities, for example, X-band radio frequency communication. In order to accommodate different frequencies and/or protocols used by external satellites, the satellite 330 can include a software-defined radio 339 that can be programmed at the instruction of the tracking system to match the frequencies and protocols used by the external satellite. Similarly, the tracking system 305 instructs that satellite when to be available for communication with the external satellite and the expected location of the satellite with which it is to communication. It uses this location information, for example, to configure a phased antenna array 338 to point toward the external satellite. The software-defined radio essentially emulates the communication characteristics of a ground station (e.g., ground station 110 of FIG. 1) in order to receive the offloading of data from the external satellite. Within the satellite 330, the offloaded data may be restructured (e.g., packetized) in a communication controller 336 for passing over the packet-switched network of the constellation of satellites 330 in order to reach a ground station 110 of the system.

Therefore, in addition to being configured by the tracking system 305 to maintain inter-satellite links 340 between the internal satellites 330, some of the satellites are further configured to establish and maintain communication links with external satellites 160, including for the purpose of offloading data from those satellites.

There are various ways of coordinating operation of an external satellite 160 in order that it can establish a communication link with an internal satellite 330 and offload its data. Some of these ways differ in the degree of coordination or control of the external satellite by the tracking system 305.

In one scenario, the external satellite has no control by the tracking system 305. An operator of the external satellite 160 makes a request of the tracking system 305 to provide a communication session or sessions for the external satellite. At least conceptually, this request is not unlike a request that the satellite operator might make of a satellite ground station operator to provide a ground link for the satellite at a time that the satellite will be accessible by that ground station. However, in this case, the request is for an inter-satellite link. The external satellite operator provides at least some tracking information for the external satellite, or alternatively provides identification information that permits the tracking system 305 to obtain tracking information from a third-party tracking system. In any case, in conjunction with the request, the tracking system 305 gains sufficient information to predict the trajectory of the external satellite, and determines when that external satellite could communication with a satellite 330 of the constellation with suitable communication components for communicating with the external satellite. Having determined the satellite 330 that will service as the access point to the data network, the tracking system 305 provides tracking information to the external satellite operator that permits it to command its external satellite 160 with information needed to point toward the access satellite 330 at an agreed upon time to establish a communication link 350 (e.g., as illustrated in FIG. 7). In some examples, the tracking information provided to the external satellite operator is of the form of one or more locations of virtual ground stations that the external satellite can use to track the location of the access satellite 330.

Even with no direct control of the external satellite 160 by the tracking system 305, it is possible that with sufficient mutual information about their relative locations, the access satellite 305 and the external satellite 160 can adaptively track each other once at least some communication is established. For example, a link 350 may initially be established using a scanning procedure, and once established the link can be maintained using an adaptive procedure.

In another scenario, an external satellite operator relinquishes as least some control of the external satellite 160, for example, allowing the tracking system 305 to directly instruct the external satellite with information needed to establish future links, and to receive telemetry information from the external satellite that is sufficient for it to plan (e.g., simulate) the future trajectory in order to plan the future network structure needed to support communication with the external satellite. Therefore in this scenario, and operator of an external satellite may request communication services from the tracking system 305, but rather than merely receiving tracking information suitable for the external satellite to point toward an access satellite, the external satellite provider may relinquish some control and the tracking system 305 may communicate directly with the external satellite 160, for example, via a ground station 110 or via access satellites in its constellation.

Generally, in at least some operational scenarios, the system operates through a set of phases including the following:

1. Metadata Collection: The satellites, ground stations and external satellites are all be characterized to setup the network for sending, receiving, routing or downlinking data.

2. Satellite Capability Analysis: For each satellite in orbit, the latest telemetry data is used to determine the spacecrafts state, and thus its operational capacity.

3. Operational Overrides: If an individual satellite is not fit for communication, it can be temporarily disabled and/or calibrated by an operator.

4. Data Path Generation: The data routing path is constructed from the deduced state of the ASI Satellite Network.

5. Task Generation and Dissemination: Given a routing path, an entity-specific task set is generated to carry out preparations and link establishment. The Task Set is then sent to the participating satellite entities.

6. Feedback: The deduced state can be validated after the fact from command and control transmissions, and the task completion status can be advertised to interested parties.

Using a network in this way provides key features that are not available with the current use of remote sensing satellites. The system enables one or more of the following:

1. A hybrid solution of RF and/or Optical connectivity to any LEO imaging satellite with sufficient capabilities regardless of communication scheme

2. Communication links between satellites and ground stations at any pre-scheduled time

3. Low/reduced latency and continuous data delivery with sufficient preparation

4. Higher throughput due to increased communication times

5. Routing to a select ground station

6. Increased resiliency due to multiple routing paths and available ground stations

7. Increased resiliency due to a self-healing mesh upon loss of node(s)

8. Lower required customer satellite complexity for increased communications capability

Each of the satellites of the system can have a subset of the following capabilities.

To enable continuous low latency data delivery (Low Latency Data Relay), each satellite maintains at least two communication links, one to receive data and one to simultaneously transmit data to the next node (whether in-plane or out-of-plane) or to the desired ground station acting as a continuous bent-pipe.

To enable higher throughput (Store and Forward Relay), each node is additionally able to ingest essentially an arbitrary amount of data from an external satellite and store it on board for later transmission via a store-and-forward architecture for transmissions with less temporal urgency.

To enable real-time tasking (a Control Relay), each satellite is able to maintain at least two communication links, one to receive command and tasking data from a tasking ground station and one to simultaneously transmit this data to the next node or to the desired end satellite. This pathway maintains a bi-directional link to enable real-time tasking with feedback.

To enable the satellites to communicate with any external satellite regardless of communication scheme, the satellites are software reconfigurable, supporting a variety of communication protocols (e.g., Modems implementations).

To enable any LEO satellite with sufficient capability to connect to the network, each satellite is able to “steer” the communication link to the desired satellite without breaking the communication link with the network. The communication payload can therefore steer with sufficient speed to maintain a link with the LEO satellite. Whether this capability is satisfies may depend on what orbital planes are used by the network and the operational zones in those planes.

To enable a desired degree of network resiliency, the network route and reroute traffic according to nodal availability deduced from the global state. The network is orchestrated by the analysis of collected node telemetry and path generation may be simulated, updated and rolled out to the network. This operational capability allows the network to self-heal upon the loss of one or more nodes.

In some implementations, the optical links make use of miniaturized fine steering mirrors and gimballing systems for this exact purpose, showing pointing ranges within ±15 deg elevation and ±60 deg azimuth with slew rates up to 75 deg/s elevation and 160 deg/s azimuth. In some implementations, radio-frequency links use RF beam steering, without needing a physical gimballing system.

The satellite constellation may be tailored to service external satellites in typical remote sensing satellite orbits. There are currently two highly populated orbital regimes. The first is a Sun Synchronous Orbit (SSO) which have an inclination of roughly 95-105 deg in LEO, and the second is an Inclined Orbit.

In operation, external satellite operators make requests network links either manually via an Internet portal, or automatically via an API. Link availability is deduced in multiple phases to avoid tasking both internal and external satellites unnecessarily. In each phase, multiple entity and network simulations occur to deduce latency and internal entity operational pressure. Once a link is requested, an Earth communication channel is opened between the control station and external satellite operator to expose operational progress, creating an open-loop of control for both entities participating in the communication link (i.e., a link between an external satellite and a satellite of the system's constellation). This is a carefully staged set of operations that are done autonomously to ensure low latency and to avoid network congestion.

Assuming deterministic command and control authority on the data relay entities, a relational external entity control phase is defined in which the external satellite does not get controlled autonomously as internal satellites do, but rather the progress of their participation for is advertised purposes of future mission operations—and possibly more data relay interactions.

To gain access to the system, an external satellite operator registers for access via an Internet portal or manually via human support channels. The registration process provides input variables to preliminary and continuous simulations which will incorporate an external satellite into the data relay network. Due to the dynamic reconfigurability of the data relay entity physical communication mediums, various metadata is required for external satellite metadata collection.

Because the satellites of the system are reconfigurable, there may be various paths that can be used achieve the communication needs of the external satellite. One use case for the system is to communicate with external satellites that currently exist in orbit or satellites that already have a well-established communication pipelines to ground stations that cannot be modified. External link scheduling is performed concurrently or as a result of the multiple simulation phases of the internal data relay satellites. However, some simulations are built upon learned behavior during operations.

The system does not implement 1:1 attitude control simulators, therefore link opportunities are presented to external entity operators given some basic simulations against the metadata provided at registration time. As external satellites are incorporated into the system's edge, they are simulated in-line with internal data relay nodes. These simulations involve:

Simulation Phase 1: Locate data relay network entry points via TLE SGP4

Propagation.

Simulation Phase 2: Participant attitude control for Link establishment. Typically worst-case control authority.

Simulation Phase 3: Medium Link Budget and data transmission estimation. Derived from lab testing.

Simulation Phase 4: Control Phase estimation. Derived experimentally.

Some of these simulations can be avoided if the external satellite operator provides detailed metadata to the system operator. Some can also be avoided on request given that the external satellite is already prepared to establish a link or has done their own simulations to determine link acquisition success. The internal operations infrastructure typically runs all simulations as the network topology changes, but many of these simulations can run on-demand by external satellite operators to gain insight into the data relay network for purposes of future use. Link capability and overall network performance is constantly held in an optimal state given the scheduled participants and is advertised to all registered external entities.

External satellite operations pipelines should be aware of an attempted scheduled link's progress and completion status. As the system operates time-based peer-to-peer links, large data transmissions may not complete over a given link. The internal operations infrastructure compiles both human and machine-readable reports to give operators and operations pipelines the ability to re-task their entities for new links to complete transmissions. During each operational data relay satellite's command and control communications, external satellite link attempts and progress is transmitted to Earth for processing and reporting. At this time, the ingested external satellite data is held on the participating internal data relay satellite until the next network task is decided. The external satellite operations pipeline is notified of the link status and progress and is presented with and expiring option to proceed with data relay operations—delivering the collected data to Earth, or to reserve that same internal data relay satellite for another link so data can be aggregated locally before downstream data relay can proceed. This added complexity is sometimes needed for specific communication MODEM implementations or required if the Analytical Space, Inc. data relay node is participating in a full-duplex link where data processing is required—e.g., CCSDS File Transfer Protocol. In the typical case as the Analytical Space, Inc. data relay network carries OSI Layer 2 payloads, aggregation can occur arbitrarily.

As it may require many data relay links to complete a single unit of external satellite transmission, data streams are organized for both in-orbit and Earth-based data aggregation to take place. Each Protocol Data Unit (PDU) transmitted between internal data relay entities is wrapped in operational metadata for the purpose of organizing data streams for downstream or local aggregation—akin to IP Fragmentation and Aggregation. All data relay aggregation happens either on an internal satellite, or on a secure data processing facility on Earth. It is important to note that almost all data streams are post-processed, either to remove the operational metadata imposed by the data relay satellites, and/or to aggregate the PDU payloads into a Link-specific file for external satellite owner ingestion. The system provides and can provide many methods of final data delivery once the data exists the data relay and is present on Earth:

1. to a cloud storage provider (AWS, Google, etc.)

2. via an arbitration deliver data upon request (FedEx, sftp, etc.)

3. internal hosting of data with time expiration

Upon link completion and acknowledgement of data retrieval, the final downlink internal satellites are instructed to delete and clear related data. The internal satellites are instructed to never delete or purge data unless absolutely necessary as a result of external entity operator approval. However, intermediate internal entities can purge data as it is reliably transmitted to another internal entity. Data storage is “lazy” in the sense where it is likely not be released/deleted until other data needs to replace it—holding on to data for as long as possible for the unexpected need for very delayed retransmissions.

### 4 Converter Satellites

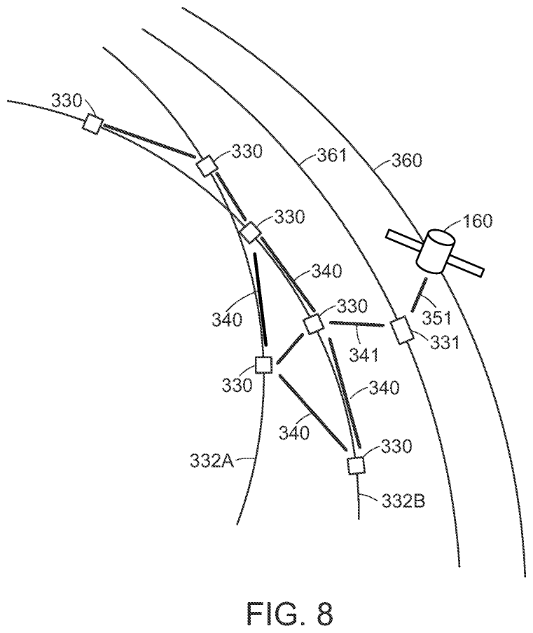

Referring to FIG. 8, in some embodiments, the internal satellites 330 of the constellation are not equipped with communication capabilities needed to communicate with an external satellite 160. Rather, as shown in FIG. 8, an external satellite 160 is on an orbit 360. A “converter” satellite 331 is put into an orbit 361 such that it maintains reasonable proximity to the external satellite 160 on an ongoing basis or at least for substantial periods of time. The converter satellite 331 has a communication system that matches or can be adapted to communicate with the external satellite, and essentially emulate a ground station for the external satellite, in the manner described with reference to FIG. 7. The converter satellite has one of more communication components that are suitable for communicating with the constellation of internal satellites 330. For example, the converter satellite has one phased array and one optical communication component. Furthermore, the converter satellite may have internal storage allowing it to offload data from the external satellite even when it is out of contact with the network of internal satellites 330. The converter satellite 330 is controlled along with the internal satellites 330, but does not necessarily act as an intermediary node forwarding communication in the data network.

In some scenarios, the converter satellite may be launched and put into an orbit to serve particular external satellites. Alternatively, converter satellites are put into an orbit to service and area of high density of external satellites, for example, that use orbits that are particularly suitable for remote sensing of particular surface areas of the earth.

Note that in some examples, a converter satellite may be launched after the external satellite is in service. This permits the converter satellite to be configured with communication components that are particularly adapted to one or more external communication frequency bands and protocols, and particularly adapted to communicate with an existing constellation of internal satellites 330. In some examples, the converter satellite is operated by a different entity than operates the constellation of internal satellites, but has an agreement to connect with inter-satellite links to the constellation. In this way the converter satellite may be operated as a “middle man” providing data communication conversion services in space. In some examples, an operator of remote sensing satellites already in orbit may launch converter satellites to provide virtual ground stations for its existing sensing satellites to offload data to a communication constellation. For example, a service provider that operates a satellite constellation for linking ground stations may provide the capability to connect third party satellites to its constellation if they have suitable compatible communication components. Therefore, such converter satellites may be launched to provide the bridge necessary to link existing remote sensing satellites to the communication services of the communication constellation.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A communication system comprising:
a plurality of interface satellites configured to communication with satellites of a constellation of satellites;
a ground-based controller in communication with the plurality of interface satellites;
wherein the system is configured to provide a communication service to at least one external satellite, the communication service providing a data path from the external satellite via one or more of the plurality of interface satellites and the constellation of satellites to a ground station.

2. The communication system of claim 1, wherein the constellation of satellites provides communication services between satellites of said constellation and the ground station.

3. The communication system of claim 2, wherein the constellation of satellites is operated independently of the interface satellites.

4. The communication system of claim 2, wherein the constellation of satellites is part of the communication system.

5. The communication system of claim 1, wherein the ground-based controller is configured to receive a connection request from an operator of the external satellite, and to provide connection information to the operator sufficient for said operator to configure the external satellite to communicate with the one of more of the interface satellites.

6. The communication system of claim 5, wherein the connection information comprises location information for at least one of the system satellite and time information specifying a time for the communication between the external satellite and one or more of the interface satellites.

7. The communication system of claim 5, wherein the ground-based controller is configured to receive tracking information of the system satellites suitable for predicting orbital information for said interface satellites, and to receive tracking information for the external satellite, and to determine the connection information based on said received tracking information for the interface and external satellites.

8. The communication system of claim 5, wherein the connection request includes a specification of a communication method for use in communicating with the external satellite, and the ground station is configured to instruct at least on interface satellite to configure a communication component to use the communication method for communicating with the external satellite.

9. The communication system of claim 8, wherein the specification of the communication method includes at least one of a communication frequency, a communication protocol, and a signaling modem.

10. The communication system of claim 1, wherein at some of the interface satellites include reconfigurable communication components for communicating with the at least one external satellite.

11. The communication system of claim 10, wherein the at least some of the interface satellites are reconfigurable based on commands from the ground-based controller.

12. The communication system of claim 10, wherein the at least some of the interface satellites are reconfigurable to emulate a communication method of a satellite ground station compatible with the at least one external satellite.

13. The communication system of claim 1, wherein the ground-based controller is configured to receive a connection request from an operator of the external satellite, and to provide connection information from the operator sufficient for the ground-based controller to take at least some control of the external satellite for the purpose of establishing communication with the one of more of the interface satellites.
